(19) United States
(12) Patent Application Publication
(10) Pub. No.: US 2005/0229768 A1
(43) Pub. Date: Oct. 20, 2005

(54) Cutting accessory for a manual vegetable cutter

(76) Inventors: Julien de Buyer, Le Val d'Ajol (FR); Jean Noel Mathieu, Vagney (FR)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 10/845,641

(22) Filed: May 14, 2004

(30) Foreign Application Priority Data
Apr. 16, 2004 (FR) 04 03 984

(51) Int. Cl. B26B 3/00; B26D 1/02

(52) U.S. Cl. 83/856; 83/932; 99/537; 30/278

(57) ABSTRACT

A cutting accessory, more particularly for a manual vegetable cutter is constituted by a holding body of a synthetic material, in which is inserted a first principal edge of a straight metal blade the rectilinear or undulating opposite principal edge of which constitutes the cutting edge, the cutting accessory, on the one hand, being produced by the implementation of an injection-moulding process in accordance with which the cutting blade is positioned in the injection-moulding machine and the holding body is moulded around it and, on the other hand, comprising, at the level of the connection between the holding body and the cutting blade and on either side of the blade, two coinciding rectilinear lips extending substantially parallel to the principal edges of the blade, characterized in that the cutting blade is equipped with a series of holes which are aligned along the connection lips and at the level thereof to allow the synthetic material constituting the holding body to pass through the blade during the injection-moulding operation.

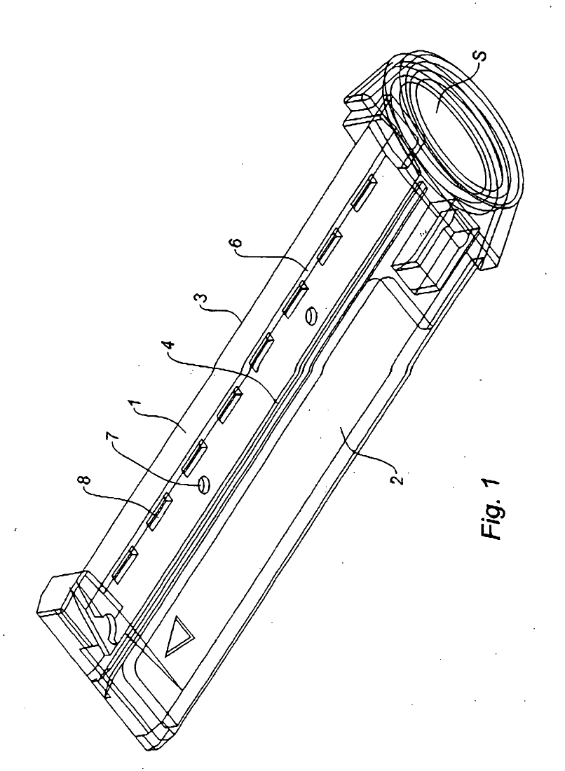

### FIELD OF THE INVENTION

The present invention relates to a cutting accessory, more particularly intended for a manual vegetable cutter, by way of example, for a safety manual vegetable cutter for both domestic and professional use.

### BACKGROUND OF THE INVENTION

A safety manual vegetable cutter typically comprises a frame provided with at least one cutting blade mounted transversely relative to a slot for the passage of the cut vegetables, as well as two lateral rails for guiding a guide chamber as it translates to and fro; the guide chamber is equipped with a space for receiving vegetables to be cut and cooperates with a pusher; the pusher is intended to be gripped manually by the user in order to move the guide chamber to and fro along the guide rails whilst constantly exerting a pressure on the vegetables contained in the receiving space so as to apply them against the cutting blade which is mounted on the frame and to enable them to be cut by that blade.

A vegetable cutter of this type is equipped with a series of transverse cutting blades which are mounted on respective removable and interchangeable cutting accessories that can be positioned and snapped onto the frame selectively.

More precisely, each of these cutting accessories is constituted by a holding body of synthetic material in which is inserted a first principal edge of a straight metal blade the opposite principal edge of which constitutes the cutting edge or sharp edge.

It should be noted that a cutting accessory of this type may be equipped with blades which are provided with rectilinear cutting edges or with undulating cutting edges of various shapes.

These cutting accessories can be mounted selectively in the cutting position facing the slot for the passage of the cut vegetables, according to whether smooth or grooved slices are to be produced.

The holding body of each cutting accessory may advantageously comprise a marking which the user can relocate on the frame when the blades are put in place to ensure that they are inserted in the correct direction and with the cutting portions on the correct side.

As a general rule, a cutting accessory of this type is produced by implementing an injection-moulding process in accordance with which the cutting blade is positioned in the injection-moulding machine and the holding body is moulded around it.

The cutting accessory thus comprises, at the level of the connection between the holding body and the cutting blade and on either side of the blade, two coinciding rectilinear lips extending substantially parallel to the principal edges of the blade.

On account of this configuration, the cutting blade is thus sandwiched between the two connection lips of the holding body at the level of its principal edge remote from the cutting edge.

It has been found in use that, in a cutting accessory of this type, the cutting blade and the holding body are not adequately fixed together at the level of the connection lips and that the lips consequently have a tendency to lift during the cutting of hard foodstuffs such as carrots.

Scraps can consequently become wedged in the slots thus created so that the cutting accessory cannot be cleaned effectively enough to ensure satisfactory conditions of hygiene.

Moreover, in the long term, this results in a blockage such as to reduce the life of the cutting accessory considerably.

The object of the present invention is to overcome this disadvantage.

### SUMMARY OF THE INVENTION

For this purpose, the invention proposes a cutting accessory of the above-mentioned type, characterized in that the cutting blade is equipped with a series of holes which are aligned along the connection lips and at the level thereof.

The presence of these holes allows the synthetic material constituting the holding body to pass through the blade during the injection-moulding operation.

A form of plastics rivets which prevent the connection lips from lifting during the cutting of hard foodstuffs is thus obtained.

According to the invention, these holes in the cutting blade may advantageously be of substantially rectangular shape.

A portion of these holes extends beyond the connection lips so that the lips are also bordered by a series of slits.

Naturally, the dimensions as well as the spacing of the holes must be selected such that the lips remaining between them are too short to be able to lift, so as to ensure that the cutting blade is fixed firmly to the holding body in a satisfactory manner.

### DESCRIPTION OF THE DRAWING

The characteristics of the cutting accessory of the invention will be described in greater detail with reference to the appended drawing which shows such an accessory.

The accessory shown in the drawing is suitable for a safety manual vegetable cutter.

However, this is only an example which should not be considered as being in any way limiting of the invention.

### DESCRIPTION OF THE ILLUSTRATED EMBODIMENT

According to the drawing, the cutting accessory comprises a straight metal blade 1 which is inserted in a holding body 2 of synthetic material, extended by a gripping portion 5 enabling the user to grip the body without contact with the blade 1.

This cutting accessory is produced by the implementation of an injection-moulding process in accordance with which the cutting blade 1 is positioned in the injection-moulding machine and the holding body 2 is moulded around it.

The cutting blade 1 comprises two opposed principal edges 3, 4.

The outer edge 3, which may be straight or undulating, constitutes the cutting edge or sharp edge.

The inner edge 4 and the adjacent region of the cutting blade 1 are sandwiched between two thicknesses of the synthetic material constituting the holding body 2.

The cutting accessory comprises, at the level of the connection between the holding body 2 and the cutting blade 1 and on either side of the blade, two coinciding rectilinear lips 6 extending parallel to the main edges 3, 4 of the blade.

The blade 1 is also equipped with two openings 7, enabling it to be fixed firmly to the holding body 2 during the injection-moulding process, as well as with a series of rectangular holes 8 which are aligned along the connection lips 6 and at the level thereof.

These holes have the function of allowing the synthetic material constituting the holding body 2 to pass through the blade 1 during the injection-moulding operation so as to prevent the lips 6 from being able to lift during the cutting of hard foodstuffs such as carrots.

On account of this configuration, the portion of the holes 8 which is not covered by the connection lips 6 defines a series of slits bordering the lips.

1. A cutting accessory, more particularly intended for a manual vegetable cutter and constituted by a holding body of a synthetic material in which is inserted a first principal edge of a straight metal blade the rectilinear or undulating opposite principal edge of which constitutes the cutting edge, the cutting accessory, on the one hand, being produced by the implementation of an injection-moulding process in accordance with which the cutting blade is positioned in the injection-moulding machine and the holding body is moulded around it and, on the other hand, comprising, at the level of the connection between the holding body and the cutting blade and on either side of the blade, two coinciding rectilinear lips extending substantially parallel to the principal edges of the blade, characterized in that the cutting blade is equipped with a series of holes which are aligned along the connection lips and at the level thereof so as to allow the synthetic material constituting the holding body to pass through the blade during the injection-moulding operation.

2. A cutting accessory according to claim 1, characterized in that the holes in the cutting blade are substantially rectangular.
